(19) United States
(12) Patent Application Publication
(10) Pub. No.: US 2005/0226411 A1
(43) Pub. Date: Oct. 13, 2005

(54) Method of generating electronic keys for a public-key cryptography method and a secure portable object using said method

(75) Inventors: Nathalie Feyt, Cuges les Pins (FR); Marc Joye, Saint Zacharie (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: GEMPLUS, Gemenos (FR)

(21) Appl. No.: 10/518,639

(22) PCT Filed: Jun. 18, 2003
(86) PCT No.: PCT/FR03/01871

§ 371 Date: Dec. 20, 2004

(30) Foreign Application Priority Data
Jun. 19, 2002 (FR) 02/07688

(51) Int. Cl. H04L 9/00

(52) U.S. Cl. 380/44

(57) ABSTRACT

A method of generating electronic keys for a public-key cryptography method using an electronic device. In a first of two separate calculating steps, pairs of prime numbers (p, q) are calculated and stored independent of knowledge of the pair of values (e,l), in which e is the public exponent and l is the length of the key of the cryptography method. The second step is very quick and can be executed in real time by the device, in which a key d is calculated from the results of the first step and knowledge of the pair (e,l).

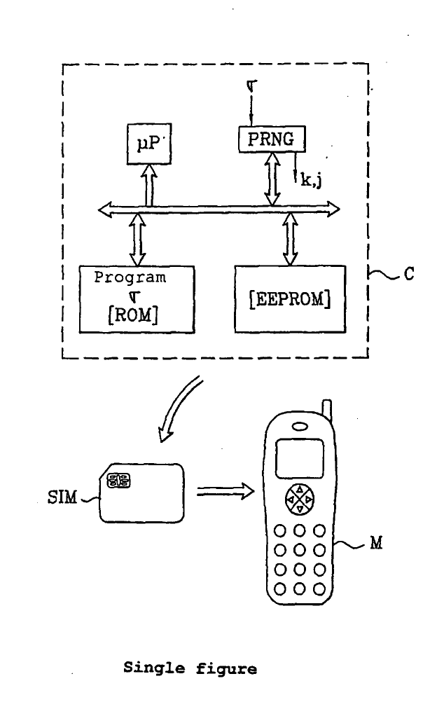

The invention relates to a method of generating electronic keys for a public-key cryptography method. It also relates to a secure portable object using the method.

The invention relates more particularly to the generation of keys for an RSA-type cryptography system and to their storage on a secure object with a view to using them in an application requiring security.

The invention applies most particularly to secure objects which do not have a large memory resource, such as an electrically programmable memory, or powerful calculation resources, as is the case for chip cards.

One application of the invention is electronic commerce using a mobile telephone. In this context, the keys may be on the SIM card of the telephone.

It is provided that some application programs use such keys to carry out a transfer of confidential data, in an electronic commerce context for example. Hereinbelow, it will be considered that these applications are provided by a service provider.

Moreover, it is known that, in order to guarantee the integrity of the key, a certificate provided by a certification authority is usually associated therewith.

Among these public-key cryptography methods, the text below deals with the RSA (Rivest Shamir and Adleman) cryptography protocol. This protocol uses a step of generating large prime numbers which takes up a lot of calculation time and memory space.

It will be recalled that this RSA cryptography protocol allows information encryption and/or authentication between two entities and/or the electronic signing of messages.

The RSA cryptography protocol is used most frequently because it has properties which allow it to be used both for encryption and for signature generation.

To do this, the RSA cryptography system comprises a “public” algorithm which performs the encryption or signature verification function and a “private” algorithm which performs the decryption or signature generation function.

The security thereof is based on the difficulty in factoring a public integer N of large size which is the product of the two secret prime numbers p and q of large size, the pair (p,q) being used in the calculation of the secret key d which is used by the decryption function or by the signature calculation function.

In order to better understand the problem which will be discussed below, a summary is given of the parameters used in an RSA cryptography scheme:
1) the public exponent e:
This is specific to an application and is provided by this application. It is thus common to all the users of this same application.
2) the parameters p and q:
These are generated from a calculation which takes up a lot of time. They usually have the same length (same size) . This length is conventionally 512 bits. In order to increase security, this length may extend from 512 bits to 2048 bits, 2048 bits being envisaged for the future.
3) N is the public modulus and is calculated from the following relation:
   N=p*q
The key of the algorithm is said to be of length l when the public modulus N is of length l. This length is set by the application (or service provider).
4) the parameters e and N form the public key.
5) the private key d is calculated from the following relation:
   d=1/e[mod(p−1)(q−1)]; (1/e=e⁻¹)
i.e. ed=1[(mod ppcm(p−1, q−1)]; ppcm is the smallest common multiple,
the secret parameters are formed by the triplet (d, p, q).
6) the “normal” form of the private key is: (d, N).
6) the CRT (Chinese Remainder Theorem) form of the private key is:

in this case the private key comprises 5 parameters:
p, q
dₚ with dₚ=d mod(p−1)
d_{q} with d_{q}=d mod(q−1)
I_{q} with I_{q}=q⁻¹ modp.

The principle of generating a key according to the RSA scheme therefore consists, as can be seen, in generating a private key d from a public exponent e (or public key) which is set by the application, the parameters p, q being generated such that p*q=N, the length l of N being fixed.

When a number of applications are provided, each service provider provides its public exponent e and the length of the public modulus N, so that the corresponding private key d can be generated.

Thus, carrying out an RSA key calculation requires knowledge of the public exponent e and of the length l of the key of the algorithm, that is to say the length of the modulus N. With the input data e and l, there remains to be generated the pair of prime numbers p and q such that the latter satisfy the following conditions:
(i) p−1 and q−1are prime numbers with e and
(ii) N=p*q is an integer of length l.

These constraints take up a lot of calculation time.

In this respect, it will be recalled that the generation and storage of keys for portable objects such as chip cards are today carried out in two ways as follows:

According to a first way, the calculation of an RSA key is carried out on a server in order to benefit from considerable calculation power. For more security, a certificate is required which is downloaded with the key within the secure object during its personalization phase.

This solution has two drawbacks:
on the one hand, despite the relatively secure context of the personalization, theft or duplication of the key may occur on account of its transfer from the server to the secure object, and
on the other hand, each key is loaded into the object in an initial personalization phase, which requires that a maximum number of keys be provided in each object in order to be able to anticipate future requirements.

In practice, there are stored in the portable object sets of keys and certificates corresponding to each application that is likely to be used, without knowing whether these keys will actually be used at a later date. A large amount of memory space is needlessly taken up. For example, 0.3 Kbytes are required for an RSA key having a modulus of 1024 bits, whereas cards at present have at most 32 Kbytes of programmable memory. Moreover, a large number of certificates is purchased from the certification authority, and this is expensive.

Last but not least is the drawback that it is not possible to add new keys as and when new applications are envisaged.

According to a second solution, the calculation may be carried out within the secure object. This overcomes the first drawback of the above solution but creates a large amount of processing within the secure object, which has a small calculation capacity.

When the generation of an RSA key is carried out by a portable object such as a chip card, if the imposed length of the RSA key is 2048 bits, the calculation then takes 30 seconds with a powerful algorithm.

Although this calculation time is acceptable for some applications since the RSA keys are generated just once for a given application, it is not satisfactory for mobile telephony services (GSM for example) since this operation is renewed each time the SIM card is changed and a larger number of keys has to be provided in order to meet the requirements of different applications.

Due to a need for considerable calculation resources, the keys are always created during the personalization phase from the public exponents e provided by the various service providers. This calculation step cannot be carried out subsequently since it would paralyze operation of the object.

In practice, this calculation is not carried out by the card. This is because this calculation is lengthy and it could slow down the personalization phase, and also its duration varies and could prove to be incompatible with the personalization methods of the chip cards.

Moreover, this solution still has the second drawback of the preceding solution, namely the need for memory space.

The object of the present invention is to solve these problems.

More precisely, the object of the invention is to solve the problem of the calculation complexity associated with managing the generation of keys and also the problem of the lack of flexibility due to the initial and definitive storage of a large number of keys and certificates during the personalization phase.

To this end, one object of the present invention relates to a method of generating electronic keys d for a public-key cryptography method using an electronic device, mainly characterized in that it comprises two separate calculation steps:

Step A
1) calculating pairs of prime numbers (p,q) or values representative of pairs of prime numbers, this calculation being independent of knowledge of the pair (e,l) in which e is the public exponent and l is the length of the key of the cryptography method, l also being the length of the modulus N of said method,
2) storing the pairs or values thus obtained;

Step B
calculating the key d from the results of step A and knowledge of the pair (e,l).

According to a first variant, step A-1) consists in calculating pairs of prime numbers (p,q) without knowledge of the public exponent e or of the length l of the key, using a parameter Π which is the product of small prime numbers. In this way, pair (p,q) obtained in step A has a maximum probability of being able to correspond to a future pair (e,l) and will make it possible to calculate a key d when step B is carried out.

According to another variant which depends on the preceding variant, the calculation A-1) also takes account of the fact that e has a high probability of forming part of the set {3, 17, . . . , 2¹⁶⁺¹}, and for this use is made in the calculation of step A of a seed σ which makes it possible to calculate not pairs (p,q) but a representative value referred to as the image of the pairs (p,q).

The storage A-2) then consists in storing this image. This makes it possible to gain memory space since an image is smaller than a prime number p or q, for example 32 bytes compared to 128 bytes.

According to a third variant, a calculation of pairs (p,q) is carried out for different probable pairs (e,l). In practice, the parameter Π will contain the usual values of e, for example 3, 17.

According to a fourth variant, step A-1) comprises an operation of compressing the calculated pairs (p,q) and step A-2) then consists in storing the compressed values thus obtained.

Step B comprises the verification of the following conditions for a given pair (e,l)
(i) p−1 and q−1 are prime numbers with e and
(ii) N=p*q is an integer of length l.

According to one preferred embodiment, step A-1) comprises the generation of a prime number q, the selection of a lower limit Bo for the length l₀ of this prime number that is to be generated, such that l₀≧B₀, for example B₀=256 bits, and it also comprises the following sub-steps:
1) calculating parameters v and w from the following relations and storing them:
   v=√2^{2l}^{₀}⁻¹/Π
   w=2^{l}^{₀}/Π
in which Π is stored and corresponds to the product of the f smallest prime numbers, f being selected such that Π≦2^{B}^{₀},
2) selecting a number j within the range of integers {v, . . . , w−1} and calculating l=j Π;
3) selecting and storing a prime number k of short length compared to the length of an RSA key within the range of integers {0, . . ., Π−1}, (k, Π) being co-prime;
4) calculating q=k+l,
5) verifying that q is a prime number, if q is not a prime number then:
a) taking a new value for k using the following relation:
k=a k (mod Π); a belonging to the multiplicative group Z*_{Π} of integers modulo Π;
b) repeating the method from sub-step 4).

Advantageously, step B comprises, for a pair (p,q) obtained in step A and a given pair (e,l):
verifying the following conditions:
(i) p−1 and q−1 are prime numbers with e and
(ii) N=p*q is an integer of length l,
if the pair (p,q) does not satisfy these conditions:
selecting another pair and repeating the verification until a pair is suitable,
calculating the key d from the pair (p,q) obtained at the end of this verification.

The invention also relates to a secure portable object able to generate electronic keys d of an RSA-type cryptography algorithm, characterized in that it comprises at least:
communication means for receiving at least one pair (e,l),
a memory for storing the results of a step A consisting in:
   calculating pairs of prime numbers (p,q) or values representative of pairs of prime numbers, this calculation being independent of knowledge of the pair (e,l) in which e is the public exponent and l is the length of the key of the cryptography method, l also being the length of the modulus N of said method,
a program for implementing a step B consisting in:
   calculating a key d from the results of step A and knowledge of a pair (e,l).

The secure portable object also comprises a program for implementing step A, steps A and B being separate in terms of time.

The secure portable object may consist of a chip card.

Other features and advantages of the invention will emerge clearly from reading the description which is given below by way of non-limiting example and with reference to the single figure which shows a diagram of a system for carrying out the method.

The rest of the description is given within the context of application of the invention to a portable object of the chip card type, and for simplification this will be referred to as a chip card.

According to the proposed method, the generation of keys is carried out in two separate steps.

The first step A comprises a calculation of pairs of prime numbers (p,q) or of values representative of pairs of prime numbers referred to as an image.

The pairs (p,q) obtained are stored.

This calculation is complex and it is even more complex if a conventional prime number generation algorithm is used.

It is proposed here that this calculation be carried out independently of knowledge of the pair (e,l).

As will be detailed below, one preferred embodiment for carrying out this step makes it possible to simplify the calculations and to limit the memory space needed to store the pairs (p,q) obtained, by storing an image of these pairs.

The second step B comprises the calculation proper of the key d from the results of step A and knowledge of the pair (e,l).

This calculation comprises, for a pair (p,q) obtained in step A and a given pair (e,l):
verification of the following conditions:
(i) p−1 and q−1 are prime numbers with e and
(ii) N=p*q, this number must be an integer of length l,
if a pair (p,q) does not satisfy these conditions, another pair is selected and the verification is repeated until a pair is suitable among the pairs obtained in step A.
it is then possible to proceed with the calculation of the key d from the pair (p,q) obtained at the end of this verification.

The first step, which corresponds to a relatively complex calculation compared to the second step, may be carried out by an element other than the chip card, for example by a server. In this case, the results of the calculation of this first step may be loaded onto a chip card during personalization.

The calculation of step A may also be carried out by the card itself at any given instant which does not disturb the user of this card. For example, this calculation may be carried out during personalization of the card or subsequently.

In practice, during use of the card, in order to obtain a service, if a private key is required then the public key is provided by the service provider (possibly remotely if it is not already stored in the card) in order to generate the private key. This generation step (calculation step B) is carried out rapidly by the card.

It can be seen therefore that new applications which require the calculation of a private key d can be provided for a card.

It can also be seen that there is no need to associate a certificate with the pairs (p,q) since they are not associated with a private key.

Thus, the generation of a private key can be carried out on board, that is to say by the card itself, with a 10-fold gain in execution time compared to the key generation methods known to date.

In the text which follows, a description will be given of one preferred embodiment for carrying out step A. This embodiment is particularly advantageous for use on board a chip card since it makes it possible to optimize both the memory space and the calculation time.

Firstly, in order to ensure that N=p*q is an integer of l bits, p is selected within the range:
└\sqrt{2^{2(l-l0)-1}},2^{l-l0}−1┘
And q is selected within the range:
└\sqrt{2^{2l0-1}},2^{l0}−1┘
For l₀ between 1 and l.

Thus, min(p)min(q) is between 2^{l0}−1 and N, and max(p)max(q) is between N and 2^{l} as required.

In this way, condition ii) mentioned above is reduced to searching for prime numbers within the range:
└\sqrt{2^{2l0-1}},2^{l0}−1┘

The proposed solution makes use of the parameter Π. This parameter Π is the product of small prime numbers among which there may be found in particular 3, 17, 2¹⁶⁺¹, which prime numbers are usually used as public exponents. Thus, the probability that a pair (p,q) will correspond to a given future pair (e,l), which is already very high, rises even further when Π comprises such values.

The f smallest prime numbers are selected, f being selected such that Πᵢpᵢ≦2B₀, B₀ is the lower limit selected for l₀. For example, B₀ may be selected to be equal to 256 bits.

Π is equal to the product: 2.3 . . . 191 and is less than 2²⁵⁶.

This value Π may then be stored in the card for example as a constant in the program read-only memory.

The first phase of the method consists in generating and storing a prime number k of short length compared to the length of an RSA key within the range of integers {0, . . . , Π1), (k, Π) being co-prime, that is to say not having a common factor.

The second phase then consists in constructing, from this number k, the first candidate q which satisfies the condition of being co-prime with Π.

If this first candidate does not satisfy this condition, then it is updated, that is to say another candidate is selected, until a value of q which does satisfy the condition is found.

A description will now be given of the various steps of the algorithm for generating a prime number that is used in the calculation of an RSA key according to the invention.

The proposed algorithm works regardless of the length lo given for the prime number q that is to be generated.

The generation of the prime number p is identical; all that is required is to replace q with p in the steps which will be developed and to replace lo with l−lo.

After having set the limit Bo, the unique prime numbers v and w which satisfy the following conditions are calculated:
√2^{2l}^{₀}⁻¹≦vΠ≦2^{2l}^{₀}⁻¹+Π
2^{l}^{₀}−Π≦wΠ≦2^{l}^{₀}

This means calculating v and w by the following relations:
v=√2^{l}^{₀}⁻¹/Π
w=2^{l}^{ₒ}/Π

Then, having taken k belonging to the multiplicative group Z*Π of integers modulo Π, the first candidate q is constructed such that
q=k+j Π for any j belonging to the range [v, w−1].

Since k matches Z*Π, the probability of having a prime first candidate q is high. If this is not the case, k is updated by taking k equal to ak(mod Π), a belonging to the group Z*Π, and the method is repeated until a value of q which corresponds to a prime number is found.

One way of testing the primality of a number is for example to use the Rabin-Miller test.

The various steps of the proposed algorithm are specifically as follows: 1) calculating parameters v and w from the following relations and storing them:
v=√2^{2l}^{_{0−1}}/Π
w=2^{l}^{₀}/Π
in which Π is stored and corresponds to the product of the f smallest prime numbers, f being selected such that Π≦2^{B}^{₀},
2) selecting a number j within the range of integers {v, . . . , w−1} and calculating l=j Π;
3) selecting and storing a prime number k of short length compared to the length of an RSA key within the range of integers {0, . . ., Π−1}, (k, Π) being co-prime;
4) calculating q=k+l,
5) verifying that q is a prime number, if q is not a prime number then:
a) taking a new value for k using the following relation:
k=a k (mod Π); a belonging to the multiplicative group Z*_{Π} of integers modulo Π;
b) repeating the method from step 4);
6) recording a, k′ j in order to use them to find q and then making use of q during a subsequent calculation to generate an RSA key.

Instead of storing the value of q, the method will advantageous proceed as described below.

A simple manner for carrying out this algorithm may consist, for each length of RSA key envisaged, in storing the values of k and j so as to reconstruct q.

Rather than selecting a random number j as indicated in step 2), another embodiment may consist in constructing j from a short random number.

For example, a number having a length of 64 bits is taken, which is referred to as the seed and is denoted σ. This seed is then taken as the input value of a pseudo-random number generator PRNG, which will make it possible to generate j.

j is then defined as PRNG₁(σ)(mod(w−v)+v).

This embodiment makes it possible to considerably reduce the requirements in terms of memory space since only the values of σ and k have to be stored in the EEPROM memory. The value of Π is in the read-only memory (in the calculation program).

It is possible to further reduce the requirements in terms of memory space by acknowledging that: if k₍ₒ₎ is the first value of k belonging to the group Z*Π, then the prime numbers generated have the form:
q=a^{f-1}k₍ₒ₎mod Π+jΠ
f being the number of failures of the test in step 4).

This value k₍ₒ₎ which belongs to the group Z*Π may be easily calculated from a short random seed, such as σ for example, and using the Carmichael function of Π² denoted λ(Å).

Using this function, it is possible to express k₍ₒ₎ by the following relation:
k₍ₒ₎=[PRNG₂(σ)+b^{PRNG3(σ)}(PRNG₂(σ)^{λ(Π)}−1)](modΠ)
b being an element of order λ(Π) belonging to z*Π.

These two embodiments make it possible to reduce the requirements in terms of memory space since in this case all that will have to be stored is the value of the seed a and various values of f for the desired key lengths.

For RSA keys having a modulus of greater than 2048 bits, the numerical experiments that have been carried out by the inventors show that f is equal to 2⁸. This means that f may be encoded on 1 byte, i.e. 8 octets.

By way of example, for generating RSA keys having a length ranging from 512 to 2048 bits with a granulity of 32 bits, there are 49 possible key lengths. It is thus necessary to store on the card one byte, i.e. 8 octets, corresponding to the value of σ. It is also necessary to store the values of f for the prime numbers p and q, i.e. 2*49=98 octets. This makes a total of 106 bytes, i.e. 848 bits, in the EEPROM memory.

A final embodiment that makes it possible to reduce the memory space consists in storing in the calculation program, that is to say in the program memory, a number of values of Π and the corresponding values of λ(Π) for various envisaged key lengths. It may be noted that a large value of Π leads to the smallest values for f.

As has been seen above, the prime number q generated according to step 4) by the algorithm which has just been described satisfies the condition:
q=a^{f-1}k₍ₒ₎mod Π+j*Π

If e divides Π, q can be expressed by the following relation:
q=a^{f-1}k₍ₒ₎mod(e)

In order that condition (i) mentioned at the start of the description is satisfied, a must be selected such that a=1(mod e) and k must be forced to be different from 1(mod e).

The prime number q obtained thus satisfies the relation q=k₍ₒ₎ different from 1(mod e).

The generation of the prime number p is identical except that q is replaced with p in the steps which have been developed and lo is replaced with l-lo.

As has been mentioned, the program that implements the method of the card does not a priori need to know the public exponent e. This exponent can therefore be provided at any moment by an application loaded into the card.

However, it is known that, for most applications (more than 95%), the values of e that are used are the values {3, 17, 2¹⁶+1}.

In order to cover the greatest number of applications, a will preferably be selected such that a=1 mod({3, 17, 2¹⁶+1}) and k₍ₒ₎ must be different from this value: 1 mod({3, 17, 2¹⁶+1}).

For example, the prime number R=2⁶⁴−2³²+1 is selected as a possible candidate for a, with the proviso that the greatest common divisor of Π and R is equal to 1.

The required condition for k₍ₒ₎ may be obtained by the Chinese Remainder Theorem.

As already mentioned, another alternative may consist, in respect of step A-1), in calculating pairs of prime numbers (p,q) for various probable pairs (e,l).

In conclusion, the invention proposes a method consisting of two separate steps, in which the second step, which is very quick compared to the known solutions, can be carried out in real time. This method also takes up a relatively small amount of memory space.

Moreover, there is no limit in terms of new applications not provided at the time of personalization of the card.

1. Method of generating electronic keys d for a public-key cryptography method using an electronic device, comprising the following two separate calculation steps:
Step A
1) calculating pairs of prime numbers (p,q) or values representative of pairs of prime numbers, this calculation being independent of knowledge of a pair of values (e,l) in which e is the public exponent and l is the length of the key of the cryptography method,
2) storing the pairs or values thus obtained; and
Step B
calculating a key d from the results of step A and knowledge of the pair of values (e,l).

2. Method of generating electronic keys according to claim 1, wherein step A-1) comprises calculating pairs of prime numbers (p, q) without knowledge of the public exponent e or of the length l of the key, using a parameter Π which is the product of small prime numbers, so that each pair (p, q) has a maximum probability of being able to correspond to a future pair (e,l) and can make it possible to calculate a key d.

3. Method of generating electronic keys according to claim 2, wherein the calculation of step A-1) also takes account of the fact that e has a high probability of forming part of the set {3, 17, . . . , [[2¹⁶⁺¹}]]2¹⁶+1}, and using a seed σ in the calculation which makes it possible to calculate a representative value constituting an image of the pairs (p, q).

4. Method of generating electronic keys according to claim 3, wherein the storage step A-2) comprises storing the image of the pairs.

5. Method of generating electronic keys according to claim 2, wherein step A-1) comprises calculating pairs of prime numbers (p, q) for different probable pairs of values (e,l).

6. Method of generating electronic keys according to claim 5, wherein the parameter Π contains the values 3, 17.

7. Method of generating electronic keys according to claim 1, wherein step A-1) comprises an operation of compressing the calculated pairs (p,q) and step A-2) in comprises storing the compressed values thus obtained.

8. Method of generating electronic keys according to claim 3, wherein step A-1) comprises the generation of a prime number q for which a lower limit B₀ is set for the length l₀ of this prime number that is to be generated, such that l₀≧B₀, and further comprising the following sub-steps: 1) calculating parameters v and w from the following relations and storing them:
v=√2^{2l}^{₀}⁻¹/Π
w=2^{l}^{₀}/Π
in which Π is stored and corresponds to the product of the f smallest prime numbers, f being selected such that Π≦2^{B}₀,
2) selecting a number j within the range of integers {v, . . . , w−1} and calculating l=j Π;
3) selecting and storing a prime number k of short length compared to the length of an RSA key within the range of integers {0, . . ., Π−1}, (k, Π) being co-prime;
4) calculating q=k+l,
5) verifying that q is a prime number, if q is not a prime number then:
a) taking a new value for k using the following relation:
k=a k (mod Π); a belonging to the multiplicative group Z*_{Π} of integers modulo Π;
b) repeating the method from step 4).

9. Method of generating electronic keys according to claim 8, wherein the numbers j and k can be generated from the seed σ stored in memory.

10. Method of generating electronic keys according to claim 8, wherein the prime number p is generated by repeating all the above sub-steps while replacing q with p and replacing l₀ with l−l₀.

11. Method of generating electronic keys according to claim 1, wherein:
step B comprises, for a pair (p,q) obtained in step A:
verifying the following conditions:
(i) p−1 and q−1 are prime numbers with a given e and
(ii) N=p*q is an integer of given length Q,
if the pair (p,q) does not satisfy these conditions:
selecting another pair and repeating the verification until a pair is suitable,
calculating the key d from the pair (p,q) obtained.

12. Secure portable object able to generate electronic keys d of an RSA-type cryptography algorithm, comprising:
communication means for receiving at least one pair of values (e,l),
a memory for storing the results of calculating pairs of prime numbers (p,q) or values representative of pairs of prime numbers, this calculation being independent of knowledge of the pair of values (e,l) in which e is a public exponent and l is the length of the key of the cryptography method, and
a program for calculating a key d from the stored results and knowledge of a received pair of values (e,l).

13. Secure portable object according to claim 12, further comprising a program for calculating said results stored in memory, the calculation of said results being separate in time from the calculation of the key d.

14. Secure portable object according to claim 13, wherein the program for calculating said results carries out the following sub-steps:
1) calculating parameters v and w from the following relations and storing them:
v=√2^{2l}^{₀}⁻¹/Π
w=2^{l}^{₀}/Π
in which Π is stored and corresponds to the product of the f smallest prime numbers, f being selected such that Π≦2^{B}^{₀}, and B₀ is a lower limit set for the length l₀ of the prime number that is to be generated, such that l₀≦B₀,
2) selecting a number j within the range of integers {v, . . . , w−1} and calculating l=jΠ;
3) selecting and storing a prime number k of short length compared to the length of an RSA key within the range of integers {0, . . ., Π−1}, (k, Π) being co-prime;
4) calculating q=k+l,
5) verifying that q is a prime number, if q is not a prime number then:
a) taking a new value for k using the following relation:
k=a k (mod Π); a belonging to the multiplicative group Z*_{Π} of integers modulo Π; and
b) repeating the method from step 4).

15. Secure portable object according to claim 12, wherein said object is a chip card.

16. Method of generating electronic keys according to claim 1, wherein step A-1) comprises calculating pairs of prime numbers (p, q) for different probable pairs of values (e,l).

17. Method of generating electronic keys according to claim 1, wherein step A-1) comprises the generation of a prime number q for which a lower limit B₀ is set for the length l₀ of this prime number that is to be generated, such that l₀>B₀, and further comprising the following sub-steps:
1) calculating parameters v and w from the following relations and storing them:
v=√2^{2l}^{₀}⁻¹/Π
w=2^{l}^{₀}/Π
in which Π is stored and corresponds to the product of the f smallest prime numbers, f being selected such that Π≦2^{B}^{₀},
2) selecting a number j within the range of integers {v, . . . , w−1} and calculating l=j Π;
3) selecting and storing a prime number k of short length compared to the length of an RSA key within the range of integers {0, . . . , Π−1}, (k, Π) being co-prime;
4) calculating q=k+l,
5) verifying that q is a prime number, if q is not a prime number then:
a) taking a new value for k using the following relation:
k=a k (mod Π); a belonging to the multiplicative group Z*_{Π} of integers modulo Π;
b) repeating the method from step 4).

18. Method of generating electronic keys according to claim 17, wherein the prime number p is generated by repeating all the above sub-steps while replacing q with p and replacing lₒ with l−l₀.
